(19) United States
(12) Patent Application Publication
(10) Pub. No.: US 2025/0120421 A1
(43) Pub. Date: Apr. 17, 2025

(54) Optimized Sustainable Formulation and Manufacturing Process for Animal and Aquaculture Feed for Enhanced Species Health and Longevity

(71) Applicants: Rachel Tinker-Kulberg, Hillsborough, NC (US); Anthony Lee Dellinger, Burlington, NC (US); Terry Earl Brady, The Valley (AI); Melinda K. M. Goddard, The Valley (AI); Lance Toland, Griffin, GA (US); Christopher L. Kepley, Montvale, VA (US)

(72) Inventors: Rachel Tinker-Kulberg, Hillsborough, NC (US); Anthony Lee Dellinger, Burlington, NC (US); Terry Earl Brady, The Valley (AI); Melinda K. M. Goddard, The Valley (AI); Lance Toland, Griffin, GA (US); Christopher L. Kepley, Montvale, VA (US)

(21) Appl. No.: 18/380,541

(22) Filed: Oct. 16, 2023

(51) Int. Cl. A23K 50/80; A23K 10/22; A23K 20/147; A23K 20/174; A23K 20/20

(52) U.S. Cl. CPC A23K 50/80; A23K 10/22; A23K 20/147; A23K 20/174; A23K 20/20

(57) ABSTRACT

The invention presents a novel feed formulation and processing optimized for horseshoe crabs in prolonged captivity, with application to myriad species. The formulation is not only sustainable but environmentally advantageous at scale by utilizing fish and poultry processing by-products. The nutrient-rich waste products are enhanced through cold-processed, enzymatic liquefication and fermentation, which preserves proteins and vitamins and thus, nutrient integrity and bioavailability. The formulation is matched to the composition of the horseshoe crab and the flora and fauna of its habitat diet. Feed efficacy can be measured by observed attraction and palatability, as well as parameters including but not limited to cellular integrity and amebocyte reactivity, weight, disease resistance, and carapace metrics. The feed matrix is designed to stimulate benthic foraging and feeding behaviors of horseshoe crabs but can be matched to alternative species feeding behaviors in aquaculture, agriculture, and other captivity settings, including nourishment of companion animals.

### FIELD OF THE INVENTION

The present invention pertains to sustainable feeds, in particular an aquaculture feed formulation for optimal health and prolonged horseshoe crab husbandry, in a departure from the customary use of fish meal comprised primarily of increasingly threatened forage fish species. The invention is further related to a process for manufacturing a nutrient-rich feed using fish and poultry by-products, incorporating a specialized matrix, fermentation and essential vitamins and minerals. Alternative embodiments of the composition are broadly designed with utility beyond horseshoe crab husbandry for a diverse spectrum of captive species, from fish to marine mammals, to terrestrial livestock, zoological settings, and companion animals, for enhancing overall health and longevity, as well as mitigation of captivity-induced disease.

### BACKGROUND OF THE INVENTION

Marine pharmacognosy focuses on the development of clinically significant products obtained from marine species (Malve, 2016). A common limitation in this sector is a lack of viable and sustainable supplies of unique compounds (Lindequist, 2016). Both wild and aquacultured marine organisms produce medically useful compounds with myriad clinical and manufacturing applications (e.g., anti-inflammatory, neuroprotective, antiparasitic, antiviral, anticancer, antimicrobial, antimalarial, etc.). Two keystone species commonly associated with this space are the Atlantic (Limulus polyphemus) and Asian (Tachypleus tridentatus) horseshoe crabs.

In fact, a billion-dollar LAL industry has been well established for 20 years. Annually, more than 600,000 horseshoe crabs are collected from North America shores for biological harvesting. The cells (amebocytes) extracted from horseshoe crab hemolymph (cells and plasma) represent one of the most valuable and vital substances in commercial quality assurance for product safety today, as the FDA-approved “gold standard” for bacterial endotoxin testing (BET). However, the process can result in prolonged habitat removal with deleterious effects that include hypoxia, physical injury, and impaired spawning activity. The limitations of a single annual harvest compound these issues by requiring aggressive, high-volume bleeds to fulfill global LAL demands and pose environmental, ecological, and medical risks to the sustainability of such practices.

In addition to biomedical demands, compounding factors include the use of horseshoe crabs as bait, as well as ecosystem challenges, from coastal erosion to climate change, and oceanic acidification.

These and other environmental stressors have impacted horseshoe crabs and many other species, ranging from shorebirds to forage fish, despite heightened efforts to devise effective conservation strategies to address these multifaceted challenges. While marine protection zones and new environmental policies have been explored, direct interventions like stock enhancement have been proposed as potentially more immediate solutions (Wang et al., 2020; Zhu et al., 2020). Notwithstanding these efforts, including the release of over 7.45 million hatchery-raised horseshoe crabs along the coasts of Fujian, Guangdong, and Guangxi provinces from 2010-2020, the effectiveness of these strategies remains questionable. A lack of specific release strategies and a full understanding of ecosystem dynamics have thus left doubts regarding the long-term viability of stock enhancement interventions.

While aquaculture has become an indispensable means for addressing global food demands and contributing to environmental sustainability, harnessing it for the long-term protection of species that enable vital manufacturing supply chains is still nascent. Given proven viability, maintaining a single cohort of horseshoe crabs in captivity allows for low impact harvesting to meet LAL demand while conserving wild populations to foster replenishment. That is, captive husbandry and aquaculture could provide a sustainable alternative at scale that would obviate the need and eliminate the risks from annual wild capture during peak spawning cycles.

Although advances in aquaculture suggest a promising avenue for the preservation and management of horseshoe crab populations, three decades of horseshoe crab aquaculture had not defined optimal parameters required for long-term captivity (Carmichael and Brush, 2012). Notably, sustained aquaculture (6 months) had been associated with low survival rates linked to poor water quality and inadequate nutrition, both of which place the horseshoe crab under stress and increase susceptibility to pathogens and vulnerability to captivity-induced disease (Kautsky, 1982; Smith and Berkson, 2005; Defoirdt et al., 2007; Carmichael et al., 2009; Nolan and Smith, 2009; Schreibman and Zarnoch, 2009; Kwan et al., 2014). The most notable malady of captive horseshoe crabs has been panhypoproteinemia; whereby, hemolymph protein concentrations drop below 3.4-11.7 mg/mL after 3-4 months (Nolan and Smith, 2009). This syndrome is caused by nutritional deficiencies and results in protein-losing enteropathy and nephropathy, as well as hepatic insufficiency (Nolan and Smith, 2009). In fact, specific dietary requirements for many established and emerging aquaculture species, as well as the digestibility of common feedstuffs, have not been fully characterized. As an exotic species, the horseshoe crab has been no exception in this milieu.

As such, while previous research has determined the feeding preferences of horseshoe crabs in their natural habitat, there has been relatively little work to establish the diet of horseshoe crabs in aquaculture, with most captive feed comprising frozen marine sources, such as shrimp, krill, mussels, sprat, squid, mackerel and other forage fish (Botton, 1984). Freezing and thawing natural feed sources can also cause water-soluble vitamin loss through diffusion at erratic, non-linear rates (Rigdon and Drager, 1955; Dierenfeld et al., 1991). This process adds additional inconsistencies since water-soluble vitamins can be lost through diffusion. For example, thiamin (vitamin B1) is rapidly degraded by naturally present thiaminase in the animal tissue (Rigdon and Drager, 1955). Likewise, vitamin E undergoes rapid peroxidation, even under ideal freezing conditions, leaving captive animals particularly susceptible to deficiencies when consuming thawed frozen fish sources (Dierenfeld et al., 1991). Furthermore, as bacterial enzymes invade the tissue of frozen fish, numerous micronutrients can undergo significant compositional changes (FAO, 1995). Vitamin B is naturally present in fish but is likewise susceptible to enzymatic digestion during storage (Joseph and Antrim, 2010); feed sources are thus typically low in vitamins B and E (Mazzaro et al., 2016). Each of these compositional disparities has no doubt complicated efforts to provide a sustainable, salubrious horseshoe crab diet necessary for successful aquaculture over the long term-including efforts to introduce synthetic feed.

While common macronutrient and caloric densities have been matched in aquaculture operations using natural feed sources, against this backdrop, synthetic feeds have notably yielded significant advantages in fish farming for rapid growth and consistency. In fact, most manufactured feed is formulated for the type and life stage of the species and is intended to stimulate consumption and rapid growth. However, to avoid deficiencies, high levels of forage fish-derived protein meal and oil are routinely added to feed production. Synthetic feeds offer affordability, reliability, and nutritional specificity, but a key challenge has been the processing of pelletized fish meal from wild-capture forage fish.

That is, using forage fish, also called baitfish, for fish meal has become increasingly problematic, as they provide essential sustenance for seabirds, finfish, and marine mammals. In turn, as forage fish are ever more threatened and as their environment is increasingly contaminated with human and industrial pollution, there is also little control over marine-derived feed ingredients that can impede aquaculture growth, resulting in economic losses and the potential for human disease (Dorea, 2006). Moreover, the ongoing threat of forage fish collapse has accentuated the gravity of sustainability issues, in addition to environmental impacts from seine-net fishing. Such methods can devastate sea floor ecosystems and result in by—catch of unintended marine mammals and larger fish wasted in the primary catch.

Coincidentally, to keep prices competitive and growth rates high, rather than specifically addressing sustainability, recent synthetic fish farm feedstock formulations have also incorporated alternative sources of proteins and lipids, including some globally traded commodities, such as fish meal and fish oil, rice, soybean, corn and wheat. Thus, such feed prices have been subjected to market volatility and have increased as much as 250% over the last 10 years. To maintain farming margins, more affordable aquafeed alternatives have thus proven indispensable, as they comprise 60-80% of total operational costs (Rana, 2009). Nonetheless, while replacement of fish meal and oils with plant proteins and oils decreases costs, it has been shown to diminish feed palatability, digestibility, and nutrient bioavailability, which has consequently intensified environmental waste pollution (NRC, 2011; Daniel, 2018).

Clearly, seafood is essential for global food security and human nutrition, providing some 4.5 billion people with 15% of typical animal protein consumption (Allison, 2011; Beveridge, 2013). Yet, this sector has grappled with the challenge of ensuring a consistent and optimal feed supply while working to meet increasing demands. In the US, aquaculture operations have historically struggled economically. In response, many operations have expanded into higher-value species for human consumption. As operations have intensified, the need for effective and sustainable feeds has continued to grow 8-10% per annum and is estimated to reach $185 billion by the end of 2023 (FAO, 2016; Nikolik, 2016). However, despite growth in this sector, a dedicated horseshoe crab-specific commercial feed for long-term animal husbandry and nutritional maintenance remains absent from the market.

In the wild, most aquatic animals are opportunistic feeders and consume a diverse array of prey. Whereas, as noted, “natural” diets for captive species are typically limited to deceased, frozen and thawed, costly aquatic sources, often exposed to prolonged storage (Crissy and Spencer, 1998). The quality and nutrient composition of these natural feeds can fluctuate, leading to dietary inconsistencies, complicating dosage parameters, and requiring frequent adjustments. As the global demand for affordable protein from fish farming—and the corresponding need for effective aquaculture feedstock—have intensified, an array of innovative formulations and methods of preparation have thus been developed and patented to address the associated challenges and opportunities. These have included:

Patent PCT/US2009/054898, Aquaculture feed, products, and methods comprising beneficial fatty acids, describes a range of inventions related to improving the nutritional quality of aquaculture-raised animals and their products. The invention is centered on the inclusion of oils derived from transgenic plants engineered for high stearidonic acid (SDA) content and subsequent inclusion in the aquaculture feed. The approach differs from conventional practice by offering a substantial SDA component in soybeans and soy oil, avoiding the drawbacks associated with fish oil and flaxseed. Furthermore, PCT/US2009/054898 teaches aquaculture meat products with specific SDA, eicosapentaenoic acid (EPA), gamma linolenic acid (GLA) and docosahexaenoic acid (DHA) concentrations, alongside methods for production thereof. The invention discloses a composition for aquaculture feeds consisting of SDA derived from transgenic vegetable oil, as well as methods for raising fish with improved fatty acid profiles and a crustacean feed. In contrast, PCT/US2009/054898 diverges from the proposed patent in composition by inclusion of terrestrial plant-based proteins and lipids. While these practices align with traditional aquaculture industry practices and are predominantly associated with reducing raw material costs and the reliance on wild capture fish, plant-derived aquaculture feeds fail to meet the precise nutritional requirements and health parameters required for long-term aquaculture species husbandry.

PCT/US2011/047412, Improved aquaculture feed compositions, pertains to specialized aquaculture feed compositions enriched with EPA and optionally DHA at a ratio exceeding 2:1 (EPA: DHA), based on their individual concentrations. Further, the feed composition comprises a total EPA and DHA content of at least 0.8% by weight. The patent teaches that the sources for these fatty acids are variable, with EPA derived from microbial oil and potentially fish oil or fish meal, while DHA can be obtained from microbial oil, fish oil, fish meal, or a mix thereof. A distinctive feature involves using microbial oil sourced from cultured transgenic microbes, preferably Yarrowia lipolytica, genetically engineered to produce polyunsaturated fatty acid-rich microbial oil with EPA content. PCT/US2011/047412 speaks to the use of fish waste, in reference to fish meal, defining fish meal as material, either produced from fishery waste products and associated with processing of fish for human consumption, or material produced from specific fish (i.e., forage fish) which are harvested solely for the purpose of producing fish meal. However, all embodiments of PCT/US2011/04712 fail to teach the use of fish offal and poultry offal obtained from industrial aquaculture and agriculture waste streams, nor does the patent disclose or teach cold process enzyme liquification and subsequent fermentation of the material.

Japanese patent JP2847295B2, How to feed fish farm feed, teaches an enhanced aquaculture feed composition aimed at improving nutritional quality, attractiveness to the target species, and feeding efficiency. The feed is comprised of annelids, aquatic insects, and extracts, or dried products, of zooplankton as both a nutritional and attraction supplement. The patent further discloses that ground fish and shellfish at specific ratios are essential ingredients. Additionally, the feed can be fortified with nutritional supplements like crushed fish offal, egg yolk, and livestock and poultry liver, constituting about 3 to 30% by weight of the mix. Oils and fats rich in unsaturated fatty acids and specific vitamin and mineral supplements may be included into the feed composition to ensure nutritional value. The final feed, once prepared, is preferably frozen for storage. For feeding, the composition is filled in an extrusion container with a nozzle designed to simulate an annelid, ensuring the feed maintains its shape and doesn't disintegrate easily when extruded. The prior art of JP2847295B2 diverges from the art of this present patent in raw material composition, matrix constituents, and delivery methods but is silent regarding the use of cold-processed enzyme treatments and fermentation of the aquaculture or agriculture remnants prior to manufacturing.

Chinese patent CN111139190A, Monascus strain, fermented soybean meal thereof and functional biological feed for aquatic products, describes the use of a specific strain of Monascus for fermenting soybean meal, aimed at improving the immunity, survival rate, and production performance of aquatic animals. This Monascus strain, when used to ferment soybean meal under controlled conditions produces functional metabolites including monascus pigment, protease, statins, amylase, lipase, ergosterol, gamma-aminobutyric acid, and others. The resultant fermented product contains small peptides and stimulates superior pigmentation compared to other strains tested under identical conditions. The patent describes that feeding the Monascus-fermented soybean meal to aquatic animals boosts growth rates and immunity, as well as enhanced body color, raising ornamental value. CN111139190A further provides details on the formulation of an aquatic, functional biological feed, using 0.5-5.0% fermented soybean meal for shrimp, crab, and oceanic and freshwater fish. The proposed patent diverges from CN111139190A in the utilization of by-products from fish and chicken processing as a rich source of essential nutrients and natural probiotics. This contrasts with the teachings of CN111139190A, which is centered on fermenting soybean meal using a particular Monascus strain. In the proposed invention, fermentation of cold-processed fish and poultry by-products ensures comprehensive breakdown of essential nutrients, enhancing their bioavailability and optimizing intestinal flora, which is particularly beneficial for long-term husbandry and rearing of a target species, such as the horseshoe crab. Additionally, the proposed process herein promotes the synthesis of bacterial proteins, resulting in feed with enhanced nutritional value. The proposed patent also offers a more complete approach to feed quality validation, including immunity, cellular composition and related health parameters of a captive animal for long-term husbandry.

Chinese Patent CN103783326B, The fermentation materials method of preparation and use of a kind of food organism bed for Procambius clarkii cultivation, teaches a unique methodology for enhancing the cultivation of Procambius clarkii (crayfish) using a specifically fermented food organism bed. This bed is prepared using select ingredients such as wheat bran, corn cob, straw powder, zeolite powder, chicken excrement, calcium superphosphate, xanthohumic acid, water, and a compound probiotic. The fermentation process includes mixing these components in stipulated ratios and fermenting them under controlled conditions, followed by drying and packaging. Once prepared, this fermented material is integrated with pond bed mud and serves as a direct feed source for the crayfish; it also promotes the growth of zoobenthos (i.e., Limnodrilus hoffmeisteri) and aquatic plants (i.e., waterweed and hydrilla verticillate). The approach claims related benefits, including better water quality, enhanced growth of aquatic plants, energy-saving due to efficient oxygenation, and reduced cultivation risks. The prior art describes, regarding Procambius clarkii cultivation is directed to fermenting specific ingredients, including wheat bran, corn cob, and chicken excrement, to produce a specialized food organism bed. The proposed invention differs from CN103783326B by specifically utilizing cold-processed, enzyme-treated, and fermented by-products from fish and poultry processing as a source of essential nutrients and probiotics to support long-term aquaculture husbandry. The proposed patent also derives benefits from the fermentation of fish and poultry offal that ensures optimal nutrient bioavailability, gut health, immunity, cellular integrity, and water quality.

US Patent US20180310593A1, Fishing bait prepared from farm mortality, pertains to the utilization of farm mortality protein sources, especially farm animals that have died due to natural causes. The composition encompasses approximately 50% to 100% by weight of this farm mortality protein source. It may also contain, in varying weight percentages, additional protein sources, preservatives, binding agents, attractants, and pH balancing agents. A salient feature of the application is the process of preparing the composition: it involves freezing the expired farm animal, followed by grinding it to form the primary component of the fish bait. The application specifically highlights a method to enhance biosecurity by freezing the expired farm animal onsite, transporting the frozen remains to a processing center, and grinding it remotely to mitigate risks of disease at the farm. Additionally, US20180310593A1 suggests the potential use of the composition in aquaculture, noting its capability to attract species like fish, mollusks, and crustaceans when introduced to their aquatic habitat. The proposed patent differs from the teachings of US20180310593A1 in the use of cold-processed, enzyme-treated, and fermented fish and poultry offal ingredients that are utilized to create a nutrient-rich feed that enhances gut health, nutrient absorption, cellular protein composition, immunity and overall longevity in captive species over an extended period of husbandry. In contrast, the art of US20180310593A1 focuses on the use, freezing and grinding of expired livestock protein sources that are not subjected to fermenting.

Chinese Patent CN101999527A, Immune feed additive and preparation method thereof, describes a method of converting waste from fishery product processing into a high nutrient-absorption-rate feed additive with immunologic benefits derived from fly maggots. The maggots are cultivated using the fermented waste and are then subjected to enzymolysis to obtain the desired feed additive. The formulation includes specific components, such as amino acids, crude proteins, and active probiotics. The approach ensures environmental sustainability by repurposing fishery by-products, and the resulting feed additive promotes growth and immunity in animals. Additionally, the additive offers high digestibility rates and presents a cost-effective alternative to imported fish meal. The method of CN101999527A emphasizes a biotechnological production process that is both environmentally friendly and efficient for large-scale industrial production. While CN101999527A describes an aquaculture feed additive composition of fermented fishery by-product waste used to raise flying maggots that are then processed as a secondary additive, the present proposed patent emphasizes the utilization of cold-processed fish and poultry by-products, which are fermented to enhance the feed's nutritional and probiotic characteristics as derived from these waste streams for optimal gut health, nutrient absorption, cellular protein composition, immunity and overall longevity in captive species over an extended period of husbandry. Furthermore, the proposed patent emphasizes the utility of cold-processed enzyme fermentation for breaking down crude protein and fibers, which significantly diverges from reliance on fly maggots and their enzymolysis.

In PCT/US2011/057835, Fermentation process to produce natural carotenoids and carotenoid-enriched feed products, a method for producing nutrient-rich animal feed products by introducing microorganisms, especially species of yeast, into a feed material is described. Specifically, PCT/US2011/057835 teaches the fermentation of organic feed materials with carotenoid-producing yeast species to produce a nutrient-enhanced feed material with carotenoids levels of at least 100 mg/kg. Additional processing forms the finished animal feed product. The art described in PCT/US2011/057835 thus focuses on the production of nutrient-enriched animal feed specifically through fermentation with carotenoid-producing yeasts. Whereas the proposed invention focuses on cold-processed enzymatic fermentation of fish and poultry by-products, enhancing the feed's overall nutritional value, gut health, and immunity for aquatic life. The distinct raw materials inclusions and fermentation process of this proposed patent maximizes nutrient bioavailability, ensures the complete breakdown of proteins, carbohydrates, and fibers, and optimizes intestinal flora, immunity, and cellular protein levels to support longevity in captivity.

United States Patent U.S. Pat. No. 9,510,568B2, System and method for shrimp aquaculture, describes a shrimp aquaculture system that uses two types of fermentation feeds that are aimed at ensuring increased survival and production rates, and an efficient feed conversion rate. The patent teaches the production of both a liquid-fermentation feed and a solid-fermentation feed using soybean and fat-free soybean powders. The liquid-fermentation variant is developed in an anaerobic environment within an airtight container, emphasizing its solubility in water, low environmental impact, and ease of decomposition. In contrast, the solid-fermentation feed is produced in a permeable container under aerobic conditions and contains a combination of aerobic bacteria, anaerobic bacteria, and facultative microorganisms. The blended fermentation approach provides a diverse and rich nutrient profile for shrimp aquaculture. In contrast to U.S. Pat. No. 9,510,568B2 which utilizes soybean-based fermentation feeds to improve shrimp survival and growth, the proposed patent teaches the nutritional value of cold-processed fish and poultry by-products, focusing on their fermentation to optimize nutrient bioavailability and foster probiotic growth for long-term husbandry, immunity, and cellular protein integrity. While the proposed patent and the prior art of U.S. Pat. No. 9,510,568B2 involve fermentation, the distinct sources of fermentation substrates (fish and poultry by-products versus soybean), methods of fermentation, and their applications reflect clear distinctions.

US Patent US20160135483A1, Aquaculture feed formed from fermented soybean meal and earthworm meal, including the fermentation preparation method for the mixture ingredient, discloses a method for producing an aquaculture feed that involves combining soybean meal and earthworm meal into a powder form. This mixture is hydrated, and a culture of Bacillus subtilis is introduced. The feed undergoes fermentation by incubating for 12 to 72 hours at temperatures optimized for Bacillus subtilis bacteria growth. The feed is subjected to a sterilization process (heating to ˜100° C.) before introducing the bacterial culture and after fermentation for purity and feed safety. The fermented feed mixture is then dried to reduce water content to roughly 10% or less. As differentiated above, the proposed patent diverges from US20160135483A1 in composition, fermentation methods and application.

US Patent US20100175441A1, Bioproduction of hydrolysate from squid processing byproducts for aquaculture feed ingredient and organic fertilizer, discloses an environmentally low impact bioproduction process, wherein hydrolysate is derived from squid processing by-products and used as an aquaculture feed ingredient and organic fertilizer. This method capitalizes on enzymatic action, primarily relying on the endogenous enzymes present in the raw materials, thereby eliminating the need for external chemical additions and making the process economical. In addition to utilizing squid processing by-products, this method also incorporates fish meat recovered from frame waste or underutilized species, like herring. The resultant squid hydrolysate serves as a feed attractant in aquaculture, promotes growth (due to the amino acid profile), improves survival rates, and enhances feed conversion ratios, potentially owing to the presence of medium molecular weight peptides and proteins. In contrast to US20100175441A1, the proposed art diverges in source material and fermentation process, whereby US20100175441A1 is directed to the use of squid processing and forage fish waste and is silent regarding the inclusion of poultry offal waste streams.

Research conducted by Mohamadsalehi and Baboli (2015) entitled, Replacement of fish meal with poultry by-product meal on body composition in practical diets for beluga sturgeon (Huso huso), focused on an aquaculture diet for beluga sturgeon (Huso huso) using poultry by-product meal (PBM). The study investigated the impact of varying levels of PBM (0% as control, 25%, 50%, 75%, and 100% replacement of fish meal) on the chemical composition of beluga sturgeon. Notably, body protein content remained consistent between the control and 25% PBM replacement. However, as the replacement level increased to 100%, there was a corresponding decrease in body protein. Conversely, lipid levels were highest in fish fed with the 100% PBM replacement formulation. The ash content of the fish also increased above the 50% PBM level, with results similar to the control group. This work thus demonstrated that PBM may represent a cost-effective alternative to fish meal, however, its effectiveness as a substitute is nonetheless dependent on its quality, which can vary based on origin and processing methods. While this work offers valuable insights into the replacement of fish meal with poultry by-product meal for beluga sturgeon, the proposed patent diverges from prior work by distinctly focusing on cold fermentation of poultry and aquaculture offal for production of an aquaculture feed with enhanced nutritional qualities and sustainability.

More generally, with respect to industrial fermentation processes, particularly in feed manufacturing, many use heat to break down materials and extract desired components. The application of heat to proteins, vitamins and other bioactive compounds is degradative and renders such components less effective or inert, as these molecules are sensitive to temperature changes and their structures can be altered or denatured. Once denatured, these molecules can lose functional properties and become ineffective. In the present invention, a cold process is utilized to avoid temperature-induced degradation of the animal by-products for optimal bioassimilation.

Ultimately, the role of nutrition is paramount, particularly for exotic species such as the horseshoe crab, given the global medical community's dependence on LAL testing. In fact, for most species, from primates in zoological parks to farm livestock and companion animals, metabolic disorders such as insulin resistance, hyperglycemia, and related maladies can arise due to dietary deficiencies, confinement-related stress and reduced activity levels. In this context, long-term aquaculture of horseshoe crabs has been demonstrated with the feed formulation presented herein and suggests broader potential for effective sustenance across a range of animals in captivity. Alternatively, it may also serve as an attractant or stimulant to enhance the appeal of less palatable feedstocks.

### SUMMARY OF THE INVENTION

The present invention describes an effective, sustainable feed formulation specifically processed and engineered to support long-term animal captivity. The nutrient-dense feed is derived from fish and poultry processing by-products and enhanced through fermentation of cold-processed fish offal. This process boosts the bioavailability of key nutrients like crude protein and carbohydrates, augments observed palatability, and fosters the synthesis of bacterial proteins, offering requisite nutrients and complexity for long-term husbandry. While the invention has been optimized to support the longevity of horseshoe crabs, its performance suggests the potential for broader applications in conventional aquaculture and agriculture feed preparations.

Specifically, the proposed aquaculture feed formulation incorporates fish and poultry by-products that include fish scales, skin, and bones, as well as chicken heads, backs, feet, and internal organs; whereby the cold-processed fish by-products (offal) are combined with the poultry by-products, fermented, and then matrix encapsulated in a blend of gelatin and collagen.

The fermentation ensures the comprehensive breakdown of crude protein, carbohydrates, and fibers, and enhances observed palatability, supports digestive flora, and promotes the synthesis of bacterial proteins, resulting in a nutritionally rich feed for extended horseshoe crab husbandry.

The primary embodiment of the invention represents the first horseshoe crab aquaculture feed formulated and processed for long-term husbandry as measured by blood chemistries and amebocyte quantity, quality and reactivity, which represent critical endpoints for horseshoe crab amebocyte harvesting. To overcome previous issues affecting captivity outcomes, animal viability and blood composition, the aquaculture feed invention is formulated based on: 1) the animal's natural diet and feeding predilections; 2) daily energy and protein requirements; and 3) the chemical composition of the horseshoe crab organism, itself, which spans biomolecules, proteins, fats, carbohydrates, minerals, and vitamins.

The formulation of the primary embodiment was determined to meet the specific nutritional of the horseshoe crab by evaluating the crude nutrient content of selected raw materials, guidance from ingredient composition tables and analysis of the chemical composition of the target organism. Nutritional analysis was conducted to assess feed efficacy, focusing on key blood indicators such as amebocyte density, the activity and concentration of the amebocyte extract, and hemocyanin concentration. These dietary evaluations were complemented by assessing long-term health parameters, including shell robustness, disease resistance, molting efficiency, and the rate of recovery following amebocyte extraction procedures. Comparing the targeted feed composition with observed results enabled stepwise refinements.

The primary embodiment has also been formulated to optimize specific parameters to ensure sustainability and mitigate environmental pollution when employed at scale using cost-effective and established sources. As horseshoe crabs are bottom feeders, these include the stability and physical form of the material with respect to “sinking” feeds with prolonged water stability to minimize environmental pollution from uneaten feed. Optimal digestibility from a soft, gelatinous form would further minimize pollution and maximize the bioaccessibility of the intended nutrients. Observed palatability and feed attraction from olfactory stimulation were also measured in feed refinements to optimize consumption and likewise minimize wasted food, thereby environmental impacts.

In the primary embodiment, the formulation was also matched to the chemical composition and nutrient profile for horseshoe crabs by analyzing their hemolymph biochemistry parameters, such as protein and copper (Table I). Notably, hemocyanin protein comprises ˜90-95% of the plasma protein, and a significant copper concentration (up to 23.13 μg mL⁻¹) is present in hemolymph. For example, a 453-gram horseshoe crab (hemolymph volume ˜33 mL) would contain approximately 763 μg of copper. Thus, the relatively low copper concentrations in natural and synthetic seawater (40-340 ng L⁻¹) identified the need for copper sulfate supplementation to the invention to maintain healthy hemolymph and promote hemocyanin production.

TABLE I
Horseshoe Crab Hemolymph Biochemistry (Mean Values).

| | | |
|---|---|---|
| Total Protein | 8.15 | g dL⁻¹ |
| Glucose | 58.5 | mg dL⁻¹ |
| Creatinine | 0.7 | mg dL⁻¹ |
| Cholesterol | 0.8 | mg dL⁻¹ |
| Sodium | 389.5 | mEq/1 |
| Potassium | 12.5 | mEq/1 |
| Chloride | 445.1 | mEq/1 |
| Calcium | 39.0 | mg dL⁻¹ |
| Magnesium | 96.1 | mg dL⁻¹ |
| Phosphorus | 3.4 | mg dL⁻¹ |
| Triglycerides | 5.3 | mg dL⁻¹ |
| Copper | 23.1 | μg mL⁻¹ |
| Amylase | 9.3 | U L⁻¹ |
| Lipase | 32.7 | U L⁻¹ |
| Alkaline Phosphatase | 12.1 | U L⁻¹ |
| Aspartate Aminotransferase | 5.4 | U L⁻¹ |
| Gamma Glutamyl Transferase | 0.92 | U L⁻¹ |

In the primary embodiment, a similar assessment was made to ensure sufficient protein concentrations in the invention feed. The typical organic composition of a horseshoe crab is: 44.03% carapace, 34.34% gonads, 10.91% meat, 8.40% gills and 2.33% viscera. Horseshoe crab shells are also predominantly comprised of calcified chitin, and the percentage of protein is considerably higher (2-5×) than those of similar species, such as snow crab and mud crab shells (Table II) which likewise suggested the need for greater levels of dietary protein in this embodiment. While obviously vital for horseshoe crab longevity, this protective shell (Table II) comprises chitin, proteins, and inorganic salts (calcium carbonate and calcium phosphate), which help ensure shell integrity. Sulfur, vital for aquatic creatures, is also required for shell formation and preservation.

TABLE II
Body Composition of Horseshoe Crab and Other Species

| Species | % Protein | % Ash | % Lipid | % Fiber |
|---|---|---|---|---|
| Horseshoe crab shell | 68.02 | 1.06 | 1.07 | 24.17 |
| Snow crab shell | 34.20 | 28.50 | 17.10 | — |
| Mud crab shell | 14.11 | 57.26 | 2.38 | — |
| Horseshoe crab meat | 14.44 | 0.55 | 1.97 | 3.75 |
| Snow crab meat | 11.90 | 2.45 | 0.28 | 2.69 |
| Mud crab meat | 16.17 | 1.82 | 0.35 | 0.39 |
| Horseshoe crab gonads | 26.10 | 0.68 | 4.87 | 6.51 |

Horseshoe Crab Shell Composition.

| | |
|---|---|
| Carbon | 53.54% |
| Oxygen | 31.13% |
| Nitrogen | 14.49% |
| Chlorine | 0.5% |
| Sulfur | 0.29% |
| Phosphorus | 0.09% |
| Calcium | 0.06% |
| Potassium | 0.05% |
| Silicon | 0.03% |

In the primary embodiment of the present invention, a stable matrix also retains moisture, minimizes nutrient leaching, allows for diffusion of chemosensory molecules, and facilitates sinking to support bottom foraging behavior in a departure from conventional methods of manufacturing and extruding aquaculture and agriculture feeds that involve high temperatures. The cold fermentation process of this invention thus ensures retained nutritional potency, as well as observed attraction and palatability.

In optimizing the primary embodiment of the invention, the feed demonstrated its utility for aquaculture production and extraction of sustainable, modified and enhanced Limulus Amebocyte Lysate or (smeLAL) applications with increased protein density and post-translational protein modifications from those at initial captivity. Eliminating stressors typically associated with wild-capture practices, the use of scientifically engineered and biologically optimized feed formulations combined with water quality management (e.g., oxygenation monitoring and optimization) allowed for batch-to-batch consistency in the smeLAL thus derived from low-impact collection from immunocompetent captive horseshoe crabs. As such, smeLAL produced with the primary embodiment in such controlled aquacultures conditions would be evident to someone skilled in the art that this invention would enable a sustainable, long-term alternative to wild-capture LAL in BET. In a similar embodiment of the invention, analogous species matching optimization would allow utility for aquaculture production and extraction of bioactive marine ingredients other than horseshoe crab amebocytes.

In another embodiment, the present invention would be species matched and optimized for food production whereby growth rates and food conversion ratios could likewise be refined. Thus, it would be obvious to one skilled in the art that the present composition would be easily adaptable for aquaculture at large, as a primary diet or a supplement to existing diets for a variety of aquatic species.

In yet another aspect, meat processing by-products (i.e., bovine and porcine), may also prove equally effective with potential supply, scale, infrastructure, raw material diversity and nutrient complexity benefits.

In other embodiments, alternative, matched feed formulations could be applied beyond horseshoe crab husbandry. That is, in addition to aquatic species, the invention could be optimized for livestock and barnyard animals, given its nutrient-rich profile, offering a sustainable alternative to conventional feeds. Additional embodiments of the proposed formulation would benefit companion animal health and allow for use as domestic pet food to offer optimal nutrient profiles. Likewise, the feed composition could cater to the unique dietary requirements of various captive wildlife species, such as those held in zoos and various wildlife facilities, or as a bait alternative for wild capture and attraction of both terrestrial and aquatic animals.

### DETAILED DESCRIPTION OF THE INVENTION

The proposed feed formulation is designed for overall animal vitality, immunity, cellular health, and well-being while in captivity. A primary embodiment of the formulation described herein is engineered to provide optimal nutrition for the long-term husbandry of horseshoe crabs. The proposed feed formulation is designed for the care and consistent year-round aquaculture of horseshoe crabs. The formulation is characterized by the balance of nutrients essential for the horseshoe crabs, factoring in a defined feed rate and the average gross energy necessary for their daily needs. Given the ancient lineage of horseshoe crabs, it would be expected that the proposed feed formulation would align with a variety of species commonly held in captivity and grown for food, as well as for long-term husbandry.

In a primary embodiment of the invention, the feed consists of cold-processed enzymatic liquification and combined fermentation of fish and poultry by-products encapsulated within a gelatin matrix. The feed formulation is further enriched with specific ratios of macronutrients, micronutrients, probiotics, prebiotics, and other essential ingredients (refer to Table III). Energy and protein maintenance requirements for horseshoe crabs are determined at 150 to 230 kJ per kg of horseshoe crab daily, approximately equating to 6.4 MJ/kg feed at a feed rate of 3% per day. The formulation also delivers the necessary protein (7.56 mg/g of horseshoe crab) and key nutrients. The feed formulation, feed rates and dietary compositions have demonstrated long-term husbandry of horseshoe crabs, maintaining stable weight, serum protein levels above 5.0 mg/mL, and maintaining immunity, outer shell integrity, cellular structure and cellular protein concentrations with high survival rates.

TABLE III
Horseshoe Crab Aquaculture Feed Formulation:

| | Percentage | Preferred | Amount | |
|---|---|---|---|---|
| Ingredient | (%) Range | Percentage (%) | (g kg⁻¹) | |
| Protein | 20-30% | 25.24% | 252 | g kg⁻¹ |
| Lipid | 4-6% | 5.07% | 51 | g kg⁻¹ |
| Fiber | 0.5-1% | 0.72% | 7 | g kg⁻¹ |
| Ash | 0.8-1.5% | 1.15% | | |
| Moisture | 60-68% | 64% | | |
| Sulfur | 3.5-4.5% | 4.1% | 41 | g kg⁻¹ |
| Vitamin C | 1-2% | 1.50% | 15 | g kg⁻¹ |
| Phosphorus | 0.8-1.2% | 0.908% | 9.0 | g kg⁻¹ |
| Calcium | 0.6-1% | 0.79% | 7.9 | g kg⁻¹ |
| Glucose | 0.5-0.7% | 0.59% | 6 | g kg⁻¹ |
| Potassium | 0.4-0.6% | 0.51% | 5.14 | g kg⁻¹ |
| Taurine | 0.35-0.45% | 0.4% | 4 | g kg⁻¹ |
| Silicon | 0.4-0.5% | 0.44% | 4 | g kg⁻¹ |
| Sodium | 0.1-0.2% | 0.15% | 1.5 | g kg⁻¹ |
| Vitamin E | 0.08-0.11% | 0.097% | 0.968 | g kg⁻¹ |
| Cholesterol | 0.03-0.05% | 0.042% | 0.424 | g kg⁻¹ |
| Phosphatidic | 0.02-0.03% | 0.026% | 0.263 | g kg⁻¹ |
| acid | | | | |
| Magnesium | 0.02-0.03% | 0.025% | 0.246 | g kg⁻¹ |
| Choline | 0.01-0.02% | 0.015% | 0.150 | g kg⁻¹ |
| Zinc | 0.004-0.006% | 0.005% | 0.056 | g kg⁻¹ |
| Copper | 0.005-0.007% | 0.006% | 0.060 | g kg⁻¹ |
| Iron | 0.008-0.01% | 0.0091% | 0.091 | g kg⁻¹ |
| Iodine | 0.007-0.009% | 0.008% | 0.080 | g kg⁻¹ |
| Niacin | 0.08-0.09% | 0.084% | 0.849 | g kg⁻¹ |
| Riboflavin | 0.01-0.02% | 0.015% | 0.147 | g kg⁻¹ |
| Thiamine | 0.015-0.02% | 0.019% | 0.119 | g kg⁻¹ |
| Vitamin B6 | 0.01-0.02% | 0.012% | 0.120 | g kg⁻¹ |
| Pantothenic | 0.07-0.08% | 0.074% | 0.742 | g kg⁻¹ |
| Manganese | 0.01-0.02% | 0.012% | 0.120 | g kg⁻¹ |

The following ingredients at less than 0.005%:

| | | | | |
|---|---|---|---|---|
| Selenium | <0.005% | 0.003% | 30 | mg kg⁻¹ |
| Cobalt | <0.005% | 0.000% | 1 | mg kg⁻¹ |
| Creatinine | <0.005% | 0.000% | 0.2 | mg kg⁻¹ |
| Biotin | <0.005% | 0.000% | 2 | mg kg⁻¹ |
| Folic Acid | <0.005% | 0.000% | 38 | μg kg⁻¹ |
| Vitamin B12 | <0.005% | 0.000% | 459 | μg kg⁻¹ |
| Vitamin A | <0.005% | 0.002% | 31,555 | IU kg⁻¹ |
| Vitamin D | <0.005% | 0.000% | 2,175 | IU kg⁻¹ |
| Vitamin K | <0.005% | 0.000% | 37 | μg kg⁻¹ |

The primary embodiment also contains approximately 16% w/v of fish offal, derived from the cold-processed enzymatic liquefaction of whole fish or select fish by-products common to aquaculture and fishing industries. The transformation process is driven by the intrinsic enzymes, which, in the presence of added acids, break down fish proteins into smaller, soluble units. The acidic environment catalyzes the enzymatic activity and plays a crucial role in inhibiting bacterial spoilage, thereby preserving the quality of the product. Compositionally, fish offal predominantly contains water, accounting for approximately 80% of its content. Proteins represent about 15%, while ash and fat constitute 4.5% and 0.5% respectively. The ash percentage is indicative of mineral content, such as calcium, phosphorus, potassium, and magnesium that are vital for animal health and growth. The inclusion of cold processed enzymatic liquefaction fish offal avoids the use of external and damaging heat to ensure intact and natural nutrient composition.

The primary embodiment also contains by-products from poultry processing, which could yield significant environmental offsets at scale. This material comprises various internal organ tissues (e.g., brain, gizzard, heart, liver, and tripe) and other non-prime parts (e.g., chicken backs), which are rich in essential nutrients, including vitamins, minerals, and micronutrients, frequently surpassing the nutritional value of more commonly consumed muscle tissues. The flesh and nutritional characteristics of poultry by-products are also analogous to the horseshoe crab natural diet of worms, mollusks, clams, crustaceans, algae, and carrion.

In the primary embodiment processing, cold-processed enzymatic liquefaction of fish offal is combined with poultry by-products and subjected to fermentation. Cold processing ensures the preservation of essential proteins, vitamins, and other bioactive compounds inherent in fish offal, thus free of deleterious effects from traditional processing methods that employ heat treated steps. Fermentation facilitates the breakdown of proteins, fibers, and carbohydrates into more bioavailable forms, enhancing nutrient absorption. Moreover, it acts as a probiotic through the proliferation of beneficial microorganisms, which can improve species digestive health and bolster immunity captive animals. Furthermore, the fermentation process naturally intensifies the observed attraction and palatability of the feed, thereby promoting ingestion.

In the primary embodiment, fish oil is also naturally present in the fish offal and provides a potent source of omega-3 polyunsaturated fatty acids (PUFAs) that contribute to the nutritional composition of the proposed feed formulation. Originating from forage fish species, these fatty acids emulate the essential lipid components typically derived from mollusks and algae in natural horseshoe crab diets. Omega-3s notably have profound anti-inflammatory properties and promote cardiovascular health, support neural functions, and ensure optimal cell membrane integrity.

In the primary embodiment, food grade, dried milk is also added to the present feed formulation as a natural source of nutrients including vitamin D, calcium, and potassium acids. In addition to foundational carbohydrates and proteins, dried milk possesses a unique fatty acid called pentadecanoic acid (C15:0). Pentadecanoic acid is a critical component in supporting cellular health and overall vitality in aquatic species. This odd-chain saturated fatty acid has also garnered significant attention in aquaculture for its potential to bolster heart health, optimize cellular functions, and mitigate inflammation.

The primary embodiment also includes macroalgae (seaweed or kelp) and microalgae (spirulina), which act as prebiotics and sources of bioavailable vitamins, minerals, and antioxidants. These also provide plant-based proteins that supply critical sulfur-containing amino acids (i.e., methionine and cysteine), which are not synthesized internally by aquatic animals and therefore must be extracted from dietary sources. Prebiotics, or non-digestible food ingredients, are normally required to stimulate the growth and activity of probiotics. The inclusion of algae in aquaculture diets also provides probiotics such as complex polysaccharides that have been shown to improve the growth and feed utilization of crustaceans such as shrimp. Dried kelp is inherently low in calories, carbohydrates, fats, and proteins, but rich in natural vitamins and minerals. Dried kelp bolsters the proposed feed formulation with significant concentrations of vitamins K, A, C, and E, in conjunction with folate, vitamin B12, and B6. This seaweed also offers a modest spectrum of B-vitamins, including thiamin, riboflavin, niacin, and pantothenic acid. Spirulina is added to the feed formulation and provides additional protein, vitamins, minerals, and antioxidants. These ingredients parallel the aquatic vegetation often consumed by various aquaculture species in their natural habitat and ensures the provision of these essential nutrients in the proposed feed formulation.

The primary embodiment of the proposed feed formulation also provides diverse minerals matched to the natural diet of the horseshoe crab. While iron is not central to horseshoe crab physiology, its presence in prey and food sources (i.e., clams) renders it a component of their natural dietary intake. Copper is a critical elemental basis for horseshoe crabs, driving oxygen transport via hemocyanin. To bolster blood health and facilitate recovery post-harvesting, the diet is enriched with creatinine and copper. While horseshoe crabs naturally produce copper in their bodies, they also extract copper from aquatic prey, such as mollusks and crustaceans. Given the importance of this mineral to the horseshoe crab primary metabolism and association with hemocyanin, fortification of the feed formulation with copper is vital for maintaining an optimal hemolymph biochemical profile.

Related amino acids are also added to the primary embodiment. These include creatinine, a by-product of muscle energy production is an indicator of organ system function. Given that horseshoe crabs routinely consume worms, clams, crustaceans, and other small animals, metabolizing these muscle tissues would represent a source of creatinine for the organism. Taurine, an amino acid, is also added, as it is naturally extracted from various prey in the horseshoe crab food web. Additionally, the presence of taurine in the invention stimulates observed feeding and foraging responses. Phosphatidic acid is also added, which is a lipid crucial for cellular functions, is either ingested from their varied diet or synthesized.

The primary embodiment also contains a diverse array of ingredients essential for shell health and chitin formation. These include: Sulfur, a fundamental element, supports numerous bodily functions, from protein synthesis to enzyme production. Similarly, silicon plays a multifaceted role in potentially aiding eye formation, as it is an integral part of the protective shell, and it is believed to serve as a nutritive element derived from their diet. The role of selenium in horseshoe crab biology and presence of trace amounts of cobalt in the shell of horseshoe crabs has yet to be fully interpreted, but their presence in natural food sources suggests beneficial inclusion in the invention. When molting or addressing shell injuries and age-related deterioration, silicon and sulfur components would play an additional role. The concentrations of creatinine, sulfur, silicon and copper in the proposed feed formulation has thus been matched to the horseshoe crab's organic composition. Manganese, a metallic element, also fortifies and provides thermal stability to the shell of the animal. Iodine plays a role in animal molting, and zinc plays a pivotal role in the embryonic development and survival of horseshoe crabs.

The primary embodiment of the proposed feed formulation further comprises a specific blend of synthetic supplements matched to their physiological needs. Dietary vitamin A augments immunity as an antioxidant and enhances hepatopancreas (digestive gland) function while mitigating lipid peroxidation. Vitamin D3, a pivotal prohormone, is also added to achieve calcium and phosphate equilibrium. Vitamin E is also added as an antioxidant to bolster immune functions. Vitamin K may assist in horseshoe crab coagulation and protein metabolism by activating key proteins. Vitamin B12 contributes to the genesis of healthy cells and neural function. Additional synthetic supplements include, riboflavin or vitamin B2 which is crucial for the synthesis of the blood clotting enzyme in horseshoe crabs, a component vital for LAL products. The feed is also enhanced with p-Pantothenic acid (vitamin B5) and Niacin (vitamin B3) to support metabolic functions. The inclusion of thiamine ensures optimal energy and nerve function, while pyridoxine facilitates protein metabolism and neurotransmitter formation. Folic acid is critical for DNA synthesis and cellular division, and it is complemented by ascorbic acid's role in collagen formulation and antioxidant defense. Finally, the primary embodiment is supplemented with biotin, which is pivotal for fatty acid genesis and energy metabolism.

Collectively, these inclusions in the proposed invention ensure the feed formulations supports horseshoe crab metabolic systems and cellular processes, fostering growth and activity during long-term captivity. They are also notably essential for shell integrity and maintaining optimum amebocyte and circulatory (hemocyanin) parameters to maximize horseshoe crab longevity in long-term husbandry.

The primary embodiment is likewise characterized by its method of manufacturing the feed formulation, which encompasses a specialized processing technique, optimized nutritional profile, and a specifically engineered delivery matrix for long-term husbandry of horseshoe crabs. The first step of the process begins with the cold-processed, enzymatic liquefaction of fish offal, harnessing their nutrient profiles (without heat-induced degradation), while maintaining the integrity of proteins, vitamins, and other bioactive compounds. Next, combining cold-processed fish offal with nutrient-dense poultry by-products establishes a synergistic base for the feed. This integrated mixture is then subjected to fermentation, promoting nutrient bioavailability by breaking down proteins and carbohydrates into digestible forms. The fermentation process enhances observed feed palatability by augmenting the attractant profile and fostering microorganism to promote microbiome diversity. Molecules released from proteins, having undergone these processes, notably correspond to organic decaying that characterizes various foodstuffs in the natural habitat. Once fermentation is complete, the processed materials are combined with other vital ingredients and prepared in a final gelatin matrix.

Thus, preparation of the primary embodiment is finished using a gelatin-based matrix to likewise correspond to the horseshoe crab natural feeding milieu. The gelatin solution, typically comprising 5-10% w/v gelatin, is prepared by dissolving in pre-heated water (60-70° C.) to achieve a homogenous mixture. Subsequently, the blend of nutrient-rich ingredients is introduced into this warm gelatin solution, mixed to achieve a thorough unification, and then allowed to congeal at ambient temperature, yielding a stable feed suitable for storage. The nutritional components are thus uniformly dispersed within a specialized gelatin matrix, which hydrates the horseshoe crab. Given the gelatin matrix, the finished embodiment can be immediately administered to aquatic organisms, refrigerated for short-term storage (up to 1-2 weeks), or frozen to extend its shelf life without loss of efficacy. Anyone skilled in the art would also know that the matrix may be modified by including lower percentages of gelatin or buoyant materials (starches or air injection/microspheres) to form a floating feed variant.

With respect to animal and habitat optimization, the primary embodiment is designed to sink for attraction and ingestion. Unlike finfish, horseshoe crabs are bottom feeders that consume feed slowly, so it must be delivered to sink. To enhance feed efficiency, minimize waste and pollution, and ensure the feed sinks, the gelatin-based matrix slows disintegration and reduces nutrient leakage into the water. With a high moisture content, the gelatin also provides a protective coating to preserve feed palatability, consistency, moisture, and stability during storage and upon delivery to the aquaculture environment. Additionally, the sinking matrix fortifies the feed's structure, while permitting controlled release of chemotactic molecules to serve as attractants that stimulate the benthic foraging and feeding behaviors of horseshoe crabs.

In other embodiments, the comprehensive nutritional profile and versatile delivery matrix of the present invention would have obvious applications that extend beyond horseshoe crab husbandry. Notably, the formulated feed could be optimized for additional species across a broader spectrum, including fish and shrimp, as well as more complex aquaculture settings (e.g., soft shell crabs and lobsters) and for high value species (e.g., salmon, sturgeon and eel). Furthermore, its adaptability could be applied for captive marine mammals, diverse agricultural livestock, companion animals, and animals housed in wildlife sanctuaries and zoological gardens. The proposed feed's unique composition, apparent palatability, and nutritional density may also be applied as a lure in trapping industries and as a nutritional source in hatcheries.

What is claimed:

1. The composition and processing of an aquaculture feed formulation matched to the habitat diet and organic composition of the horseshoe crab species for prolonged, captive aquaculture, designed to provide optimal nutrition to sustain metabolic function, immunity, cellular health, and longevity, wherein the feed comprises:
a. Cold-processed enzymatic liquefication fish offal and poultry by-products;
b. Protein, lipid and fiber macronutrients;
c. Water
d. Essential micronutrient minerals including but not limited to calcium, cobalt, copper, iodine, iron, magnesium, manganese, phosphorus, potassium, selenium, silicon, sodium, sulfur, and zinc;
e. Essential micronutrient vitamins including but not limited to biotin, choline, folic acid, niacin (vitamin B3), pantothenic acid (vitamin B5), riboflavin (vitamin B2), thiamine (vitamin B1), vitamin A, cobalamin (vitamin B12), pyridoxine (vitamin B6), vitamin C, vitamin D, vitamin E, and vitamin K;
f. Other components including but not limited to cholesterol, glucose, phosphatidic acid, prebiotics, probiotics, and taurine;
g. Gelatin matrix.

2. A method of manufacturing the aquaculture feed formulation of claim 1, comprising the steps:
a. Cold-processing and enzymatic liquefaction of fish offal to maintain the integrity of proteins, vitamins, and other bioactive compounds;
b. Combining the cold-processed fish offal with nutrient-dense poultry by-products to form a synergistic base;
c. Subjecting the mixture to fermentation to enhance nutrient bioavailability and feed palatability;
d. Integrating the fermented mixture with additional ingredients, including but not limited to macronutrients, micronutrients, probiotics, and prebiotics;
e. Combining the nutrient blend with a gelatin solution, prepared by dissolving 5-10% w/v gelatin in pre-heated water (60-70° C.), to form a homogenous mixture; and
f. Allowing the combined feed solution to solidify to yield a stable feed structure.

3. A method of producing a scientifically modified endotoxin Limulus Amebocyte Lysate (smeLAL) suitable for bacterial endotoxin testing (BET) from horseshoe crabs reared on the aquaculture feed formulation of claim 1, wherein the use of the aquaculture feed formulation results in:
a. optimal protein density in the horseshoe crab's hemolymph amebocytes;
b. post-translational modifications of proteins in horseshoe crab hemolymph amebocytes with consistent reactivity in BET and endpoint detections; and
c. a consistent, sustainable supply of smeLAL, negating the need for wild-capture LAL.

4. The aquaculture feed formulation and processing of claim 1, wherein the feed ensures animal weight consistent with growth, serum protein levels above 5.0 mg/mL, and disease resistance from immunity to common pathogens to support longevity.

5. The aquaculture feed formulation and processing of claim 1, comprising cold-processed, fermented fish and poultry by-products encapsulated in a gelatin matrix, enriched with specific ratios of macronutrients, micronutrients, probiotics, prebiotics, and other essential ingredients.

6. The aquaculture feed formulation and processing of claim 1, wherein the gelatin matrix slows feed disintegration, reduces nutrient seepage, and provides hydration to the horseshoe crab.

7. A method of producing the aquaculture feed formulation of claim 1, wherein ingredients are combined with gelatin heated to 60-70° C., and the mixture is allowed to solidify.

8. The aquaculture feed formulation and processing of claim 1, wherein the fish offal is combined with poultry by-products and subjected to fermentation, promoting synergistic nutrient bioavailability, and enhancing feed palatability.

9. The aquaculture feed formulation and processing of claim 1, wherein the primary ingredient is poultry by-products, matching a protein source to the horseshoe crab habitat diet fortified as a concentrated reservoir of vitamins and minerals.

10. The aquaculture feed formulation and processing of claim 1, further comprising fish offal derived from the cold processed enzymatic liquefaction of whole fish or fish by-products, wherein cold processing circumvents detrimental heat effects, to preserve the integrity of proteins, vitamins, and other bioactive compounds.

11. The aquaculture feed formulation and processing claim 1, further supplemented with dried milk as a source of fatty acids to bolster cellular integrity.

12. The aquaculture feed formulation and processing of claim 1, wherein said formulation is supplemented with microalgae and macroalgae, including but not limited to dried kelp and spirulina, as sources of a range of vitamins, minerals, and antioxidants.

13. The aquaculture feed formulation and processing of claim 1, wherein fish oil is integrated as a source of omega-3 polyunsaturated fatty acids to match the lipid profile of the horseshoe crab habitat diet.

14. The aquaculture feed of claim 1, further comprising a specific blend of synthetic supplements to support horseshoe crab metabolic systems in prolonged, captive aquaculture.

15. The aquaculture feed formulation and processing of claim 1, further supplemented with a diverse mineral profile to match the minerals present in the horseshoe crab habitat diet.

16. The aquaculture feed formulation and processing of claim 1, further supplemented with sulfur to support protein synthesis, enzyme production, and metabolic functions for prolonged, captive aquaculture.

17. The aquaculture feed formulation and processing of claim 1, optimized by matching the composition and natural diets for other aquatic organisms, including but not limited to fish species, shrimp, soft shell crabs, lobsters, salmon, sturgeon, and eel; wherein the gelatin matrix may further comprise buoyant elements to enable the feed to float in a water column.

18. The aquaculture feed formulation and processing of claim 1, optimized by matching the composition and natural diets for captive marine mammals, diverse agricultural livestock, companion animals, animals in wildlife sanctuaries, zoological gardens, trapping industries, and hatcheries.

19. The aquaculture feed formulation and processing of claim 1, optimized to enhance immunity and cellular health, support circulatory and organ functions, maintain calcium and phosphate homeostasis, and provide antioxidant supplementation for prolonged captive aquaculture.

20. The aquaculture feed formulation and processing of claim 1, featuring a gelatin matrix that preserves palatability and species attractants, with application to a range of animal species responsive to scent cues of carrion and decaying matter.
